(19) United States
(12) Patent Application Publication
(10) Pub. No.: US 2014/0370331 A1
(43) Pub. Date: Dec. 18, 2014

(54) METHOD OF FABRICATING ION IMPLANTATION MAGNETICALLY AND THERMALLY ISOLATED BITS IN HAMR BPM STACKS

(71) Applicant: Seagate Technology LLC, Cupertino, CA (US)

(72) Inventors: Sunnie H. N. Lim, Alameda, CA (US); Koichi Wago, Sunnyvale, CA (US)

(73) Assignee: Seagate Technology LLC, Cupertino, CA (US)

(21) Appl. No.: 14/158,704

(22) Filed: Jan. 17, 2014

Related U.S. Application Data
(60) Provisional application No. 61/836,595, filed on Jun. 18, 2013.

(51) Int. Cl. G11B 5/84; G11B 5/72

(52) U.S. Cl. CPC G11B 5/84; G11B 5/72
USPC 428/835; 427/526; 428/834; 250/492.1

(57) ABSTRACT

The embodiments disclose a continuous thin film magnetic layer and a patterned hard mask layer configured to be deposited onto the continuous thin film magnetic layer and to have plural ion implantations, wherein the ion implantations are configured to create chemically and structurally altered localized magnetic regions unprotected by the patterned hard mask layer.

### CROSS-REFERENCE TO RELATED APPLICATIONS

This application is based on U.S. Provisional Patent Application Ser. No. 61/836,595 filed Jun. 18, 2013, entitled “A METHOD OF FABRICATING ION IMPLANTATION MAGNETICALLY AND THERMALLY ISOLATED BITS IN HAMR BPM STACKS”, by Sunnie H. Lim, et al..

### BRIEF DESCRIPTION OF THE DRAWINGS

FIG. 1 shows a block diagram of an overview of a method of fabricating ion implantation magnetically and thermally isolated bits in HAMR BPM stacks of one embodiment.

FIG. 2 shows a block diagram of an overview flow chart of a method of fabricating ion implantation magnetically and thermally isolated bits in HAMR BPM stacks of one embodiment.

FIG. 3 shows a block diagram of an overview flow chart of one or more ion implantations of one embodiment.

FIG. 4 shows a block diagram of an overview flow chart of implanted ions chemical and structural alterations of one embodiment.

FIG. 5 shows a block diagram of an overview flow chart of magnetic and thermal bit isolation of one embodiment.

FIG. 6 shows for illustrative purposes only an example of first ion implantation using first ion chemical species and first voltage of one embodiment.

FIG. 7 shows for illustrative purposes only an example of second ion implantation using second ion chemical species and second voltage of one embodiment.

FIG. 8 shows for illustrative purposes only an example of magnetic bit thermal isolation of one embodiment.

FIG. 9 shows for illustrative purposes only an example of magnetic bit magnetic isolation of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a method of fabricating ion implantation magnetically and thermally isolated bits in HAMR BPM stacks is described for illustrative purposes and the underlying system can apply to any number and multiple types ion implantations. In one embodiment of the present invention, the method of fabricating ion implantation magnetically and thermally isolated bits in HAMR BPM stacks can be configured using a continuous thin magnetic layer of high Ku magnetic materials, for example, those having high magnetic anisotropy constant Ku. The method of fabricating ion implantation magnetically and thermally isolated bits in HAMR BPM stacks can be configured to include a first chemical species and can be configured to include a second chemical species using the present invention.

Currently, heat assisted magnetic recording (HAMR) technology uses localized heating of a small and confined volume in a granular high Ku material like FePt. A focused laser is used to assist this localized heating. However, currently, the energy required to elevate the temperature of the magnetic material is also causing an overheating of the head recorder. In addition, areal-density extendibility of HAMR based on granular media is limited by grain size that can be thermally instable and not give sufficient signal-to-noise ratio at the same time. Bit Patterned Media (BPM), which is based on lithographically defined bit rather than a bit, consisting of number of grains, requires isolating magnetic bits to minimize magnetic interactions.

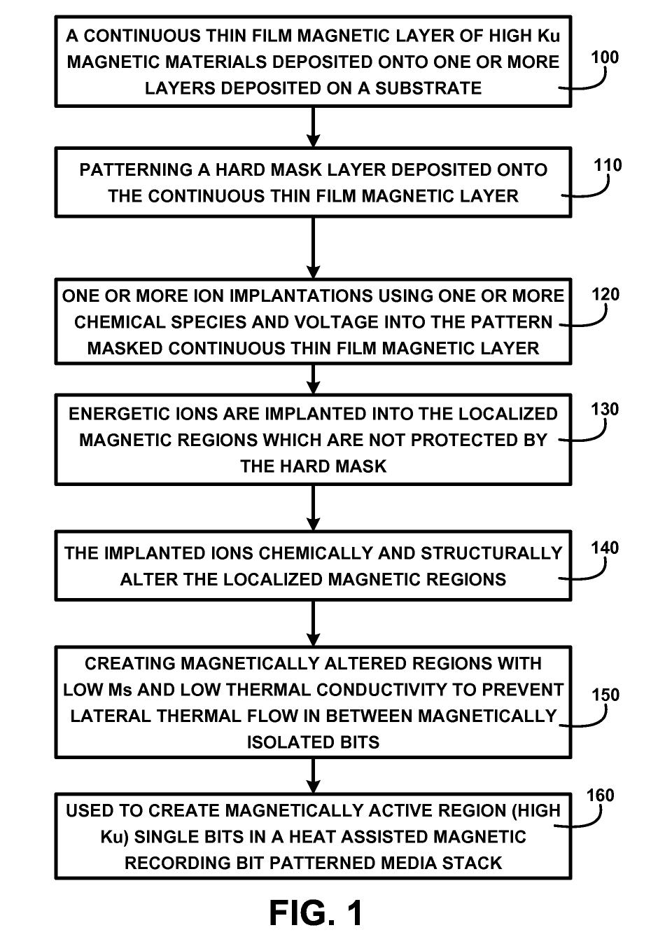

FIG. 1 shows a block diagram of an overview of a method of fabricating ion implantation magnetically and thermally isolated bits in HAMR BPM stacks of one embodiment. FIG. 1 shows a continuous thin film magnetic layer of high Ku magnetic materials deposited onto one or more layers deposited on a substrate 100. Patterning a hard mask layer deposited onto the continuous thin film magnetic layer 110. The process uses one or more ion implantations using one or more chemical species and voltage into the pattern masked continuous thin film magnetic layer 120 to pattern the magnetic layer without physically etching the magnetic materials. No physical etching prevents etch damage to the side walls of the bits. Planarization is not used since the continuous thin film magnetic layer has not been etched of one embodiment.

Energetic ions are implanted into the localized magnetic regions which are not protected by the hard mask 130 pattern. The implanted ions chemically and structurally alter the localized magnetic regions 140 creating magnetically altered regions with low Ms and low thermal conductivity to prevent lateral thermal expansion in between magnetically isolated bits 150. The sections of the continuous thin film magnetic layer protected by the hard mask patterns are used to create magnetically active region (high Ku) single bits in a heat assisted magnetic recording bit patterned media stack 160 of one embodiment.

### DETAILED DESCRIPTION

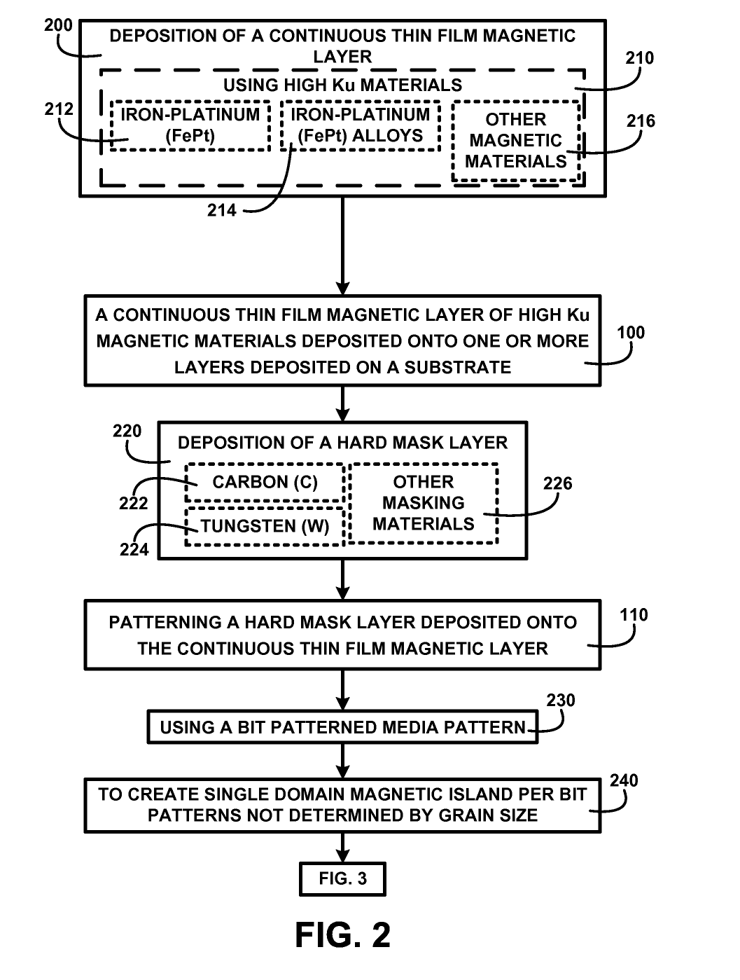

FIG. 2 shows a block diagram of an overview flow chart of a method of fabricating ion implantation magnetically and thermally isolated bits in HAMR BPM stacks of one embodiment. FIG. 2 shows a deposition of a continuous thin film magnetic layer 200 using high Ku materials 210 including iron-platinum (FePt) 212, iron-platinum (FePt) alloys 214 and other magnetic materials 216. The deposition of a continuous thin film magnetic layer of high Ku magnetic materials deposited onto one or more layers deposited on a substrate 100 is used for ion implantation. A deposition of a hard mask layer 220 using carbon (C) 222, tungsten (W) 224 and other masking materials 226 is used for patterning a hard mask layer deposited onto the continuous thin film magnetic layer 110 using a bit patterned media pattern 230. The patterned hard mask layer is used to create single domain magnetic island per bit patterns not determined by grain size 240 of one embodiment.

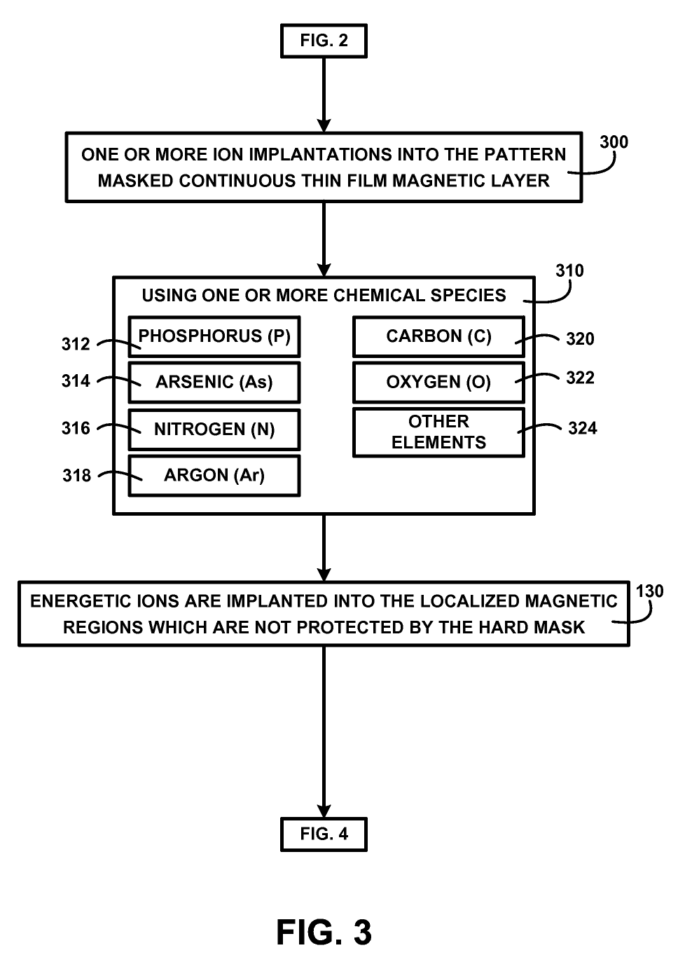

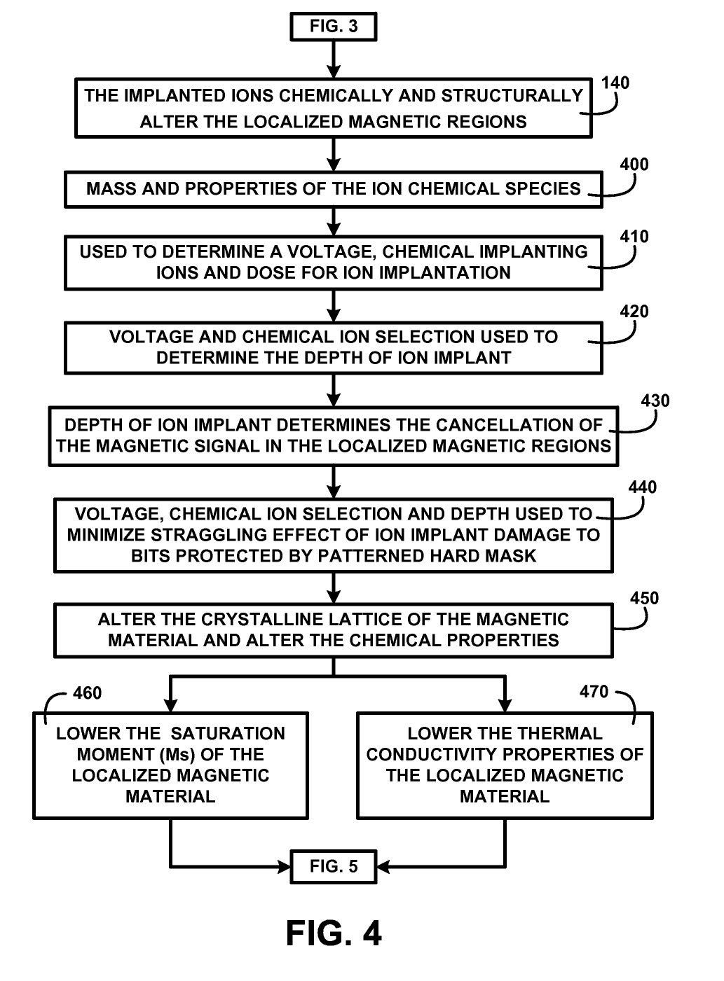

FIG. 3 shows a block diagram of an overview flow chart of one or more ion implantations of one embodiment. FIG. 3 shows a continuation from FIG. 2 showing one or more ion implantations into the pattern masked continuous thin film magnetic layer 300 using one or more chemical species 310 including phosphorus (P) 312, arsenic (As) 314, nitrogen (N) 316, argon (Ar) 318, carbon (C) 320, oxygen (O) 322 and other elements 324. Energetic ions are implanted into the localized magnetic regions which are not protected by the hard mask 130. The process is further described in FIG. 4

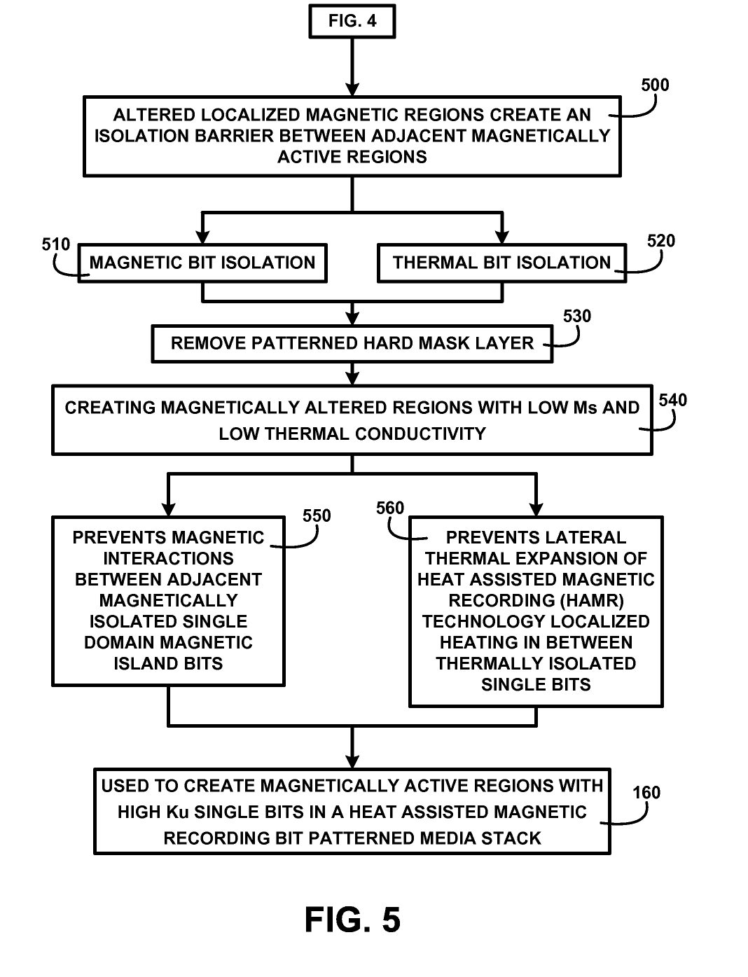

FIG. 4 shows a block diagram of an overview flow chart of implanted ions chemical and structural alterations of one embodiment. FIG. 4 shows continuing from FIG. 3 the implanted ions chemically and structurally alter the localized magnetic regions 140. Mass and properties of the ion chemical species 400 is used to determine a voltage, chemical implanting ions and dose for ion implantation 410. Voltage and chemical ion selection used to determine the depth of ion implant 420. Depth of ion implant determines the cancellation of the magnetic signal in the localized magnetic regions 430. Voltage, chemical ion selection and depth used to minimize straggling effect of ion implant damage to bits protected by patterned hard mask 440. The ion implanted ions alter the crystalline lattice of the magnetic material and alter the chemical properties 450 to lower the saturation moment (Ms) of the localized magnetic material 460 and lower the thermal conductivity properties of the localized magnetic material 470 of one embodiment. The process description continues in FIG. 5.

FIG. 5 shows for illustrative purposes only an example of magnetic and thermal bit isolation of one embodiment. FIG. 5 shows a furtherance of the process from FIG. 4 including that altered localized magnetic regions create an isolation barrier between adjacent magnetically active regions 500. The altered localized magnetic regions create magnetic bit isolation 510 and thermal bit isolation 520. A process is used to remove patterned hard mask layer 530 structures of one embodiment.

The method of fabricating ion implantation magnetically and thermally isolated bits in HAMR BPM stacks is used for creating magnetically altered regions with low Ms and low thermal conductivity 540. The ion implantation prevents magnetic interactions between adjacent magnetically isolated single domain magnetic island bits 550 and prevents lateral thermal expansion of heat assisted magnetic recording (HAMR) technology localized heating in between thermally isolated single bits 560. The method of fabricating ion implantation magnetically and thermally isolated bits in HAMR BPM stacks is used to create magnetically active regions with high Ku single bits in a heat assisted magnetic recording bit patterned media stack 160 of one embodiment.

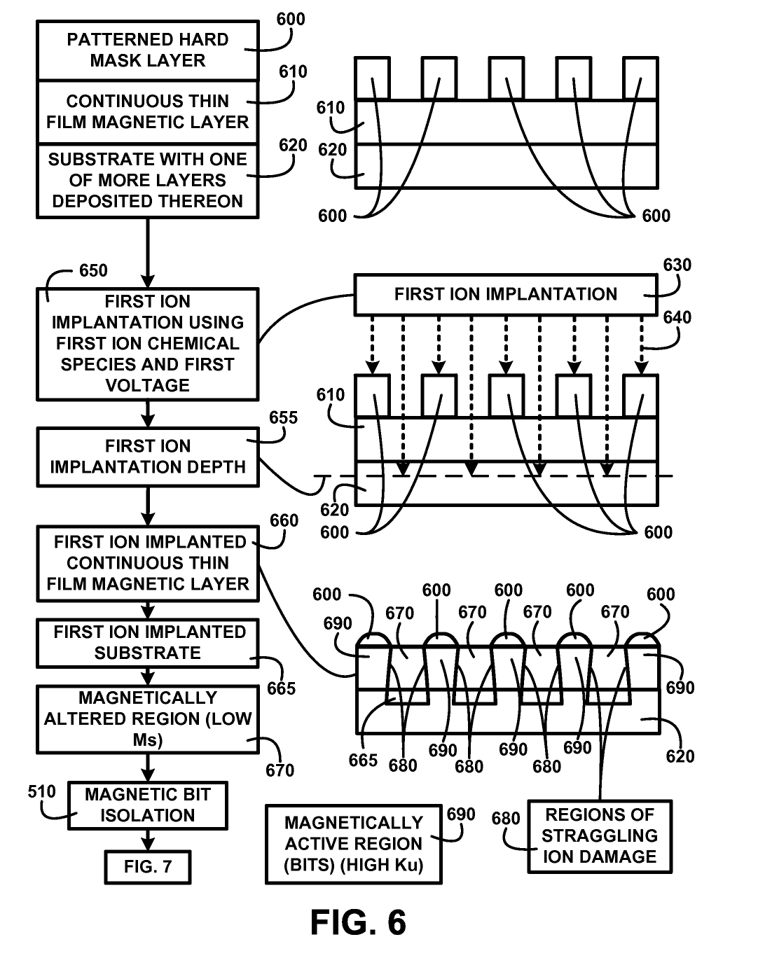

FIG. 6 shows for illustrative purposes only an example of first ion implantation using first ion chemical species and first voltage of one embodiment. FIG. 6 shows a patterned hard mask layer 600 on a continuous thin film magnetic layer 610 deposited on a substrate with one of more layers deposited thereon 620. A first ion implantation using first ion chemical species and first voltage 650 uses a first ion implantation 630 to implant first ion chemical species 640 to a first ion implantation depth 655. The first ion chemical species 640 are implanted into the continuous thin film magnetic layer 610 and substrate with one of more layers deposited thereon 620 not protected by a patterned hard mask layer 600 of one embodiment.

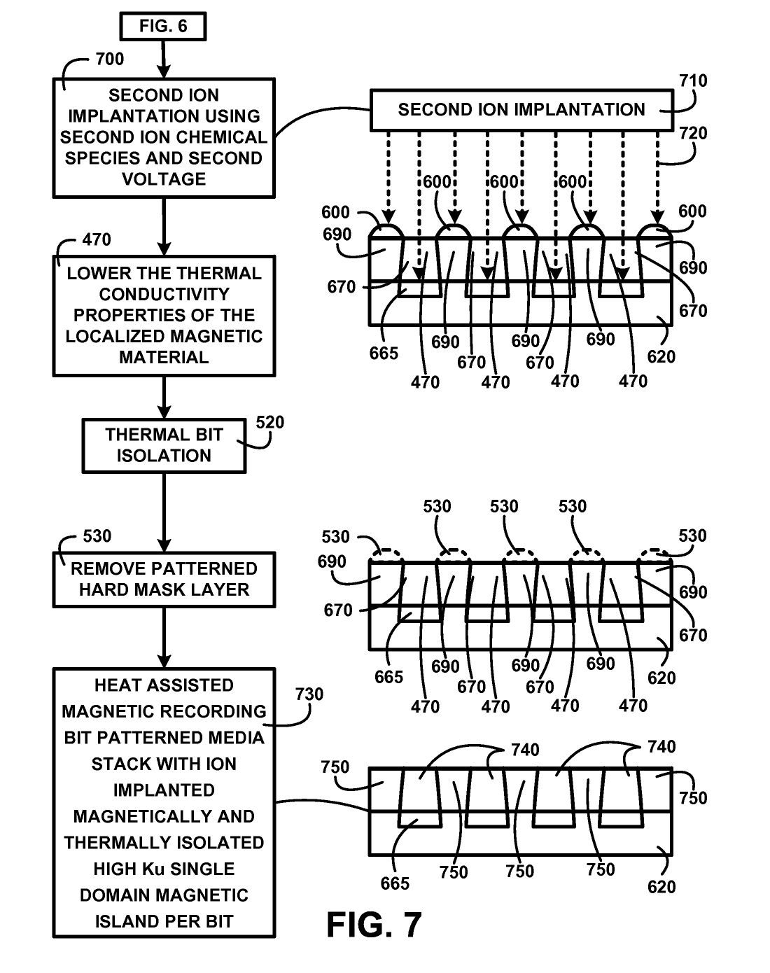

A first ion implanted continuous thin film magnetic layer 660 includes magnetically altered region (low Ms) 670 used to create magnetic bit isolation 510. The ion implantation includes regions of straggling ion damage 680. Magnetically active region (bits) (high Ku) 690 are those sections of the continuous thin film magnetic layer 610 protected beneath the patterned hard mask layer 600 of one embodiment. A first ion implanted substrate 665 is not affected by the first ion implantation 630. The processes are shown continuing in FIG. 7.

FIG. 7 shows for illustrative purposes only an example of second ion implantation using second ion chemical species and second voltage of one embodiment. FIG. 7 shows a continuation from FIG. 6 that includes a second ion implantation using second ion chemical species and second voltage 700. A second ion implantation 710 uses a second ion chemical species and second voltage 720 to chemical damage the unprotected regions of the continuous magnetic layer to lower the thermal conductivity properties of the localized magnetic material 470. In those regions unprotected by the patterned hard mask layer 600 the implanted ions alter the chemical properties of the magnetic materials to create thermal bit isolation 520 between the magnetically active region (bits) (high Ku) 690. The thermal bit isolation 520 prevents lateral thermal transfers of heat from a laser to adjacent bits. The thermal bit isolation 520 is in addition to the magnetically altered region (low Ms) 670 created magnetic bit isolation 510 of FIG. 5. The first ion implanted substrate 665 has not been affected by the ion implantation of one embodiment.

A process is used to remove patterned hard mask layer 530 and expose the lower the thermal conductivity properties of the localized magnetic material 470 and the magnetically altered region (low Ms) 670 underneath. The magnetically active region (bits) (high Ku) 690 constitute bits on the first ion implanted substrate 665 of one embodiment.

A heat assisted magnetic recording bit patterned media stack with ion implanted magnetically and thermally isolated high Ku single domain magnetic island per bit 730 includes the substrate with one of more layers deposited thereon 620. Ion implant magnetic and thermal bit isolation 740 creates the plurality of the non-etched and non-planarized high Ku single domain magnetic island bit 750 of one embodiment.

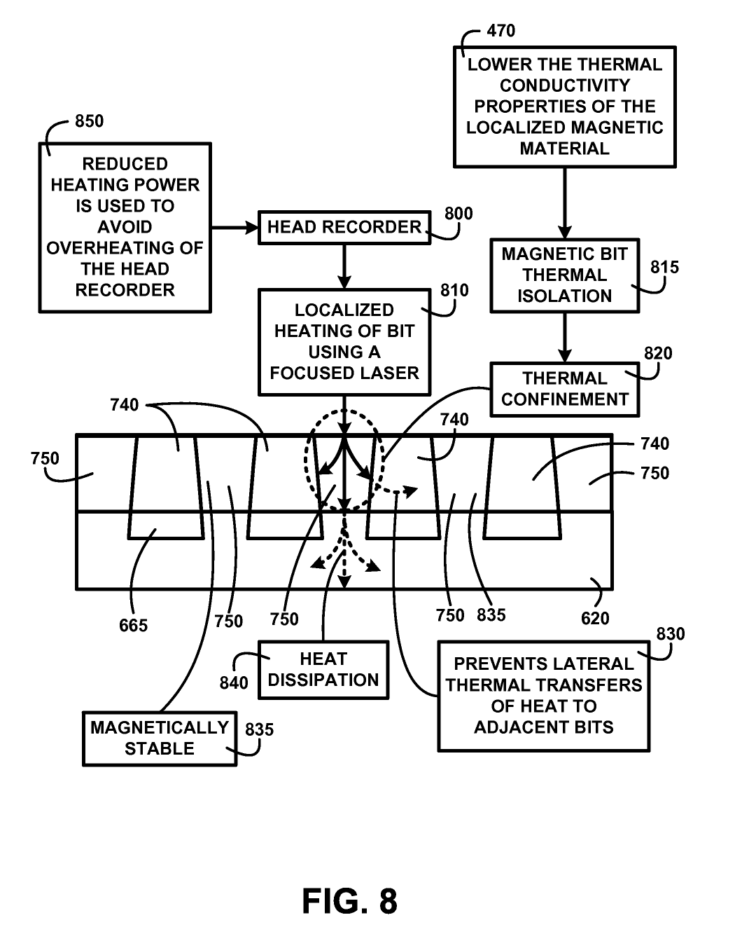

FIG. 8 shows for illustrative purposes only an example of magnetic bit thermal isolation of one embodiment. FIG. 8 shows a head recorder 800 used for localized heating of bit using a focused laser 810. The head recorder 800 is heating the high Ku single domain magnetic island bit 750 in for example a HAMR process. The high Ku single domain magnetic island bit 750 is surrounded by ion implant magnetic and thermal bit isolation 740 created by the ion implantation of the adjacent altered material. The heat dissipation 840 is directed to the substrate with one or more layers deposited thereon 620 and around the first ion implanted substrate 665. The lower the thermal conductivity properties of the localized magnetic material 470 of the ion implantation altered material creates magnetic bit thermal isolation 815 causing thermal confinement 820. The magnetic bit thermal isolation 815 prevents lateral thermal transfers of heat to adjacent bits 830 making them magnetically stable 835. The thermal confinement 820 aids in rapid heating of the high Ku single domain magnetic island bit 750 so that reduced heating power is used to avoid overheating of the head recorder 850 of one embodiment.

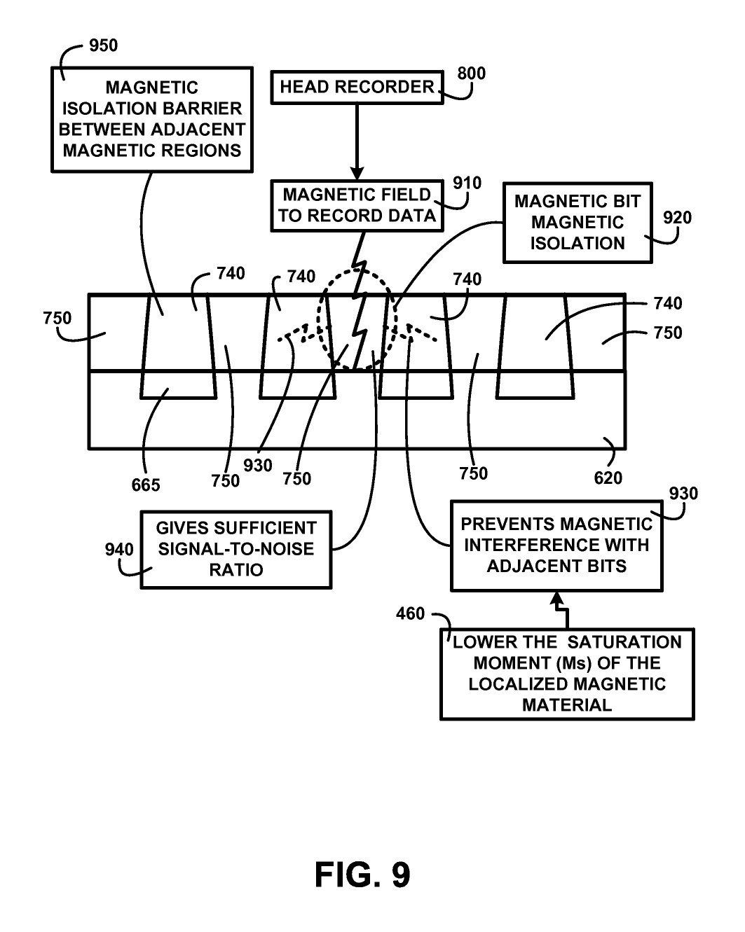

FIG. 9 shows for illustrative purposes only an example of magnetic bit magnetic isolation of one embodiment. FIG. 9 shows the head recorder 800 projecting a magnetic field to record data 910 in the high Ku single domain magnetic island bit 750. The substrate with one of more layers deposited thereon 620 and the first ion implanted substrate 665 are not affected by the magnetic field. The high Ku single domain magnetic island bit 750 is surrounded by the ion implant magnetic and thermal bit isolation 740 of the ion implantation altered material. The ion implantation is used to lower the saturation moment (Ms) of the localized magnetic material 460 causing altered material that including magnetic properties that prevents magnetic interference with adjacent bits 930. The ion implantation lowered saturation moment (Ms) of the localized magnetic material creates a magnetic isolation barrier between adjacent magnetic regions 950. The created magnetic bit magnetic isolation 920 gives sufficient signal-to-noise ratio 940 to the high Ku single domain magnetic island bit 750 for accurate recording and reading of magnetic data in a HAMR process including with BPM stacks.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method of fabricating bits in a stack, comprising:
patterning a hard mask layer;
using at least one of a plurality of ion implantations with at least one chemical species configured to implant energetic ions that chemically alter localized magnetic regions unprotected by the patterned hard mask layer; and
creating magnetically altered regions of predetermined low saturation moment (Ms) with low thermal conductivity within the stack.

2. The method of claim 1, wherein the continuous thin film magnetic layer includes predetermined high magnetic anisotropy constant Ku including iron-platinum (FePt), iron-platinum (FePt) alloys and wherein the magnetically altered regions are configured to substantially prevent lateral thermal expansion in between magnetically and thermally isolated magnetic bits in the stack.

3. The method of claim 1, wherein patterning a hard mask layer includes using bit patterned media patterns to create a single domain magnetic island per bit pattern not determined by grain size.

4. The method of claim 1, wherein at least one ion implantation substantially prevents magnetic interactions between adjacent magnetically isolated single domain magnetic island bits.

5. The method of claim 1, wherein a deposition of the hard mask layer includes using materials including carbon (C) and tungsten (W) and other masking materials.

6. The method of claim 1, wherein at least one ion implantations into the pattern masked continuous thin film magnetic layer includes using at least one chemical species including phosphorus (P), arsenic (As), nitrogen (N), argon (Ar), carbon (C), oxygen (O) and other elements.

7. The method of claim 1, wherein the implanted energetic ions chemically and structurally alter the localized magnetic regions wherein the mass and properties of the ion chemical species are used to determine a voltage, chemical ion selection and dose for ion implantation.

8. The method of claim 7, wherein a voltage, chemical ion selection and dose are used to determine a depth of ion implant and the depth of ion implant determines cancellation of a magnetic signal in the localized magnetic regions.

9. The method of claim 8, wherein the voltage and depth are used to minimize straggling effect of ion implant damage to bits protected by the patterned hard mask.

10. The method of claim 7, wherein chemical and structural alterations to localized magnetic regions includes alterations to a crystalline lattice of the magnetic material and altered chemical properties including lowering the saturation moment (Ms) of the localized magnetic material and lowering the thermal conductivity properties of the localized magnetic material.

11. An ion implantation structure, comprising:
a continuous thin film magnetic layer; and
a patterned hard mask layer configured to be deposited onto the continuous thin film magnetic layer and to have plural ion implantations, wherein the ion implantations are configured to create chemically and structurally altered localized magnetic regions unprotected by the patterned hard mask layer.

12. The structure of claim 11, wherein the continuous thin film magnetic layer has predetermined high magnetic anisotropy constant Ku configured to include at least one magnetic material including iron-platinum (FePt), iron-platinum (FePt) alloys and other magnetic materials.

13. The structure of claim 11, further comprising altered chemical and structural localized magnetic regions configured to create alterations to a crystalline lattice of the magnetic material and altered chemical properties including lowering saturation moment (Ms) of the localized magnetic material and lowering the thermal conductivity properties of the localized magnetic material.

14. The structure of claim 13, wherein the ion implantation altered localized magnetic regions prevents lateral thermal expansion and magnetic interactions between adjacent magnetically isolated single domain magnetic island bits in a heat assisted magnetic recording (HAMR) bit patterned media (BPM) stack.

15. The structure of claim 11, wherein the hard mask layer includes depositions using materials including carbon (C) and tungsten (W) and other masking materials.

16. The structure of claim 11, wherein one or more ion implantations into the pattern masked continuous thin film magnetic layer includes using one or more chemical species including phosphorus (P), arsenic (As), nitrogen (N), argon (Ar), carbon (C), oxygen (O) and other elements.

17. An apparatus, comprising:
a device used to determine a voltage, chemical ion selection and dose for ion implantation based on mass and properties of the ion chemical species;
a device used to determine a depth of an ion implantation of energetic ions that are configured to chemically and structurally alter localized magnetic regions of a pattern masked continuous thin film magnetic layer to create thermally and magnetically isolated single domain magnetic island bits in a stack including in a heat assisted magnetic recording (HAMR) bit patterned media (BPM) stack.

18. The apparatus of claim 17, wherein the voltage, chemical ion selection and dose determined by the device is used to determine the depth of ion implant wherein the depth of ion implant determines the cancellation of magnetic signals in the localized magnetic regions.

19. The apparatus of claim 17, wherein the voltage and depth determined by the device is used to minimize straggling effect of ion implant damage to bits protected by a patterned hard mask.

20. The apparatus of claim 17, wherein the voltage, chemical ion selection and depth determined by the device is used to alter a crystalline lattice of the magnetic material and alter the chemical properties including lower the saturation moment (Ms) of the localized magnetic material and lower the thermal conductivity properties of the localized magnetic material.
